(19) United States
(12) Patent Application Publication
(10) Pub. No.: US 2025/0162033 A1
(43) Pub. Date: May 22, 2025

(54) MAGNETIC ISOLATION MATERIAL WITH COUNTER POTENTIAL CRYSTALS AND PREPARATION METHOD THEREOF

(71) Applicant: Helian New energy Co.,LTD, Kunshan (CN)

(72) Inventors: CHIA-YU CHANG, Kunshan (CN); HIROKAZU NAKAJIMA, Kunshan (CN); HUIYUN HE, Kunshan (CN); HONGBIN PAN, Kunshan (CN)

(21) Appl. No.: 18/517,053

(22) Filed: Nov. 22, 2023

(51) Int. Cl. B22F 10/28; B22F 1/142; B22F 1/145; B33Y 10/00; B33Y 40/10; B33Y 70/00

(52) U.S. Cl. CPC B22F 10/28; B22F 1/142; B22F 1/147; B33Y 10/00; B33Y 40/10; B33Y 70/00; B22F 2301/205; B22F 2301/355; B22F 2302/40; B22F 2998/10

(57) ABSTRACT

The present disclosure belongs to the technical field of magnetic isolation materials, and particularly relates to a magnetic isolation material with counter potential crystals and a preparation method thereof. The magnetic isolation material with counter potential crystals includes a non-magnetoconductive layer, a fusion layer and a magnetic isolation layer. The non-magnetoconductive layer is connected with the magnetic isolation layer through the fusion layer. The non-magnetoconductive layer is made of a graphene-reinforced titanium alloy. The magnetic isolation layer is made of a graphene-reinforced iron-nickel-cobalt alloy. The finally prepared magnetic isolation material with counter potential crystals has a highly magnetoconductive surface and a non-permeable and non-magnetized matrix.

### TECHNICAL FIELD

The present disclosure relates to the technical field of magnetic isolation materials, and in particular to a magnetic isolation material with counter potential crystals and a preparation method thereof.

### BACKGROUND

A magnetic fluid seal, which is an advanced dynamic seal technique, means that by placing a fluid containing magnetic nanoparticles in a structure of an external magnetic field under the action of a carrier liquid, the magnetic fluid is concentrated in the sealing gap under the action of a magnetic loop, thus achieving the sealing effect. Magnetic fluid seals have the advantages of zero leakage and high torque transmission efficiency and can withstand high speed; and as seal parts for complex environments in aerospace and navigation, the magnetic fluid seals have received more and more attention, and have broad application prospects.

Titanium alloy has the characteristics of light weight and excellent mechanical properties, and is widely used in the fields of aerospace, chemistry, petrochemical industry and biomedicine, and is an ideal material for the rotating shaft of the magnetic fluid seal system. However, titanium alloy is also non-magnetized and non-magnetoconductive, and cannot form a loop of magnetic lines of force to meet specific working occasions. In addition, the surface hardness of the titanium alloy is low during long-term service, which will inevitably lead to wear. Therefore, for the sake of safe, stable and reliable long-term operation of the magnetic fluid seal system, it is of far-reaching significance to improve the surface properties of the titanium alloy.

Iron-nickel-cobalt alloy, which has very similar thermal expansion coefficient and characteristics to those of ceramics and glass and also has good processability, is suitable for glass packaging and photovoltaic communication module packaging, and widely used as materials for television camera tube parts and IC lead frames.

In most of the existing magnetic fluid seal systems, a highly magnetoconductive coating is attached to the surface of the titanium alloy to solve the problem that the titanium alloy is non-magnetized and non-magnetoconductive. However, this magnetic isolation material generally has the defects of poor mechanical properties, low tensile strength and yield strength, and poor heat dissipation, and cannot maintain good magnetic stability at high working temperature. There is no good combination of the titanium alloy and the iron-nickel-cobalt alloy to prepare a magnetic isolation material that has a highly magnetoconductive surface and a non-permeable and non-magnetized matrix by utilizing their characteristics to meet the use requirements of the magnetic fluid seal system.

### SUMMARY

### (I) Technical Problems Solved

In view of the defects in the prior art, the present disclosure provides a magnetic isolation material with counter potential crystals and a preparation method thereof, which solves the following problems: In most of the existing magnetic fluid seal systems, a highly magnetoconductive coating is attached to the surface of the titanium alloy to solve the problem that the titanium alloy is non-magnetized and non-magnetoconductive. However, this magnetic isolation material generally has the defects of poor mechanical properties, low tensile strength and yield strength, and poor heat dissipation, and cannot maintain good magnetic stability at high working temperature. There is no good combination of the titanium alloy and the iron-nickel-cobalt alloy to prepare a magnetic isolation material that has a highly magnetoconductive surface and a non-permeable and non-magnetized matrix by utilizing their characteristics to meet the use requirements of the magnetic fluid seal system.

### (II) Technical Solution

In order to achieve the above objective, the present disclosure specifically adopts the following technical solution:

The present disclosure provides a magnetic isolation material with counter potential crystals. The magnetic isolation material with counter potential crystals includes a non-magnetoconductive layer, a fusion layer and a magnetic isolation layer. The non-magnetoconductive layer is connected with the magnetic isolation layer through the fusion layer. The non-magnetoconductive layer is made of a graphene-reinforced titanium alloy, the magnetic isolation layer is made of a graphene-reinforced iron-nickel-cobalt alloy, and the fusion layer is formed by intermediate fusion of the non-magnetoconductive layer and the magnetic isolation layer when a temperature is reduced from 3652° C. to 1217±1.5° C.

Further, the non-magnetoconductive layer has a thickness of 15-35 μm, the fusion layer has a thickness of 5-10 μm, and the magnetic isolation layer has a thickness of 10-20 μm.

The present disclosure further provides a preparation method of the magnetic isolation material with counter potential crystals, including the following steps:
S1: preparation of non-magnetoconductive layer:
S11: adding first graphene into cetyltrimethylammonium bromide, adding acetic acid for surface modification of the graphene, and then adding the surface-modified first graphene into a DMF (N,N-dimethylformamide) solvent for dispersion to obtain a first graphene dispersion liquid;
S12: putting a titanium alloy plate with a rough surface in a drilling container, adding the first graphene dispersion liquid into the drilling container, and drilling the rough surface of the titanium alloy plate by a drill bit at a drill bit speed of 500-800 r/min and an advancing speed of 30-40 mm/min while stirring the first graphene dispersion liquid at a speed of 500-800 r/min, thereby obtaining a graphene/titanium alloy slurry;
S13: washing and drying the graphene/titanium alloy slurry to obtain graphene/titanium alloy powder; and
S14: melting and forming the graphene/titanium alloy powder by selective laser melting to obtain a graphene-reinforced titanium alloy;
S2: preparation of magnetic isolation layer:
S21: adding second graphene into cetyltrimethylammonium bromide, adding acetic acid for surface modification of the second graphene, and then adding the surface-modified second graphene into a DMF solvent for dispersion to obtain a second graphene dispersion liquid;
S22: putting an iron-nickel-cobalt alloy plate with a rough surface in a drilling container, adding the second graphene dispersion liquid into the drilling container, and drilling the rough surface of the iron-nickel-cobalt alloy plate by a drill bit at a drill bit speed of 500-800 r/min and an advancing speed of 30-40 mm/min while stirring the second graphene dispersion liquid, thereby obtaining a graphene/iron-nickel-cobalt alloy slurry;
S23: washing and drying the graphene/iron-nickel-cobalt alloy slurry to obtain graphene/iron-nickel-cobalt alloy powder; and
S24: melting and forming the graphene/iron-nickel-cobalt alloy powder by selective laser melting to obtain a graphene-reinforced iron-nickel-cobalt alloy; and
S3: preparation of magnetic isolation material with counter potential crystals: respectively fusing the graphene-reinforced titanium alloy obtained in step S1 and the graphene-reinforced iron-nickel-cobalt alloy obtained in step S2 by selective laser melting, and carrying out intermediate fusion on the graphene-reinforced titanium alloy and the graphene-reinforced iron-nickel-cobalt alloy when a temperature is reduced from 3652° C. to 1217±1.5° C., thereby finally forming the magnetic isolation material with counter potential crystals having a non-magnetoconductive layer, a fusion layer and a magnetic isolation layer, the part formed by the intermediate fusion being the fusion layer.

Further, in step S1, an amount of the first graphene added is 0.1-0.3 wt. % of a total amount of the graphene and titanium alloy powder in the graphene/titanium alloy slurry.

Further, the amount of the first graphene added is 0.3 wt. % of the total amount of the graphene and titanium alloy powder in the graphene/titanium alloy slurry.

Further, in step S2, an amount of the second graphene added is 0.1-0.3 wt. % of a total amount of the graphene and iron-nickel-cobalt alloy powder in the graphene/iron-nickel-cobalt alloy slurry.

Further, the amount of the second graphene added is 0.3 wt. % of the total amount of the graphene and iron-nickel-cobalt alloy powder in the graphene/iron-nickel-cobalt alloy slurry.

Further, in step S2, the graphene/titanium alloy slurry and the graphene/iron-nickel-cobalt alloy slurry are both dried at a temperature of 75-90° C. for 6-8 h.

### (III) Beneficial Effects

Compared with the prior art, the magnetic isolation material with counter potential crystals and the preparation method thereof provided by the present disclosure have the following beneficial effects:

1. In the present disclosure, the magnetic isolation material with counter potential crystals is prepared by partially fusing the graphene-reinforced titanium alloy and the graphene-reinforced iron-nickel-cobalt alloy. During the preparation of the alloy powder by the drill bit, the highly dispersed graphene is directly coated on the surface of the alloy powder to form a more obviously refined microstructure. The formed magnetic isolation material with counter potential crystals has a tensile strength of up to 1019 MPa and a yield strength of up to 998 MPa, obviously exhibiting more excellent mechanical properties than the prior art.

2. In the present disclosure, in view of the titanium alloy being non-magnetized and non-magnetoconductive, the graphene-reinforced iron-nickel-cobalt alloy is partially fused on the graphene-reinforced titanium alloy, which makes them well combined and also imparts a highly magnetoconductive surface to the titanium alloy. Moreover, this magnetic isolation material well utilizes high heat dissipation, high processability and low thermal expansivity of the iron-nickel-cobalt alloy, can maintain good magnetic stability at high working temperature, and improves physical and mechanical properties of the magnetic isolation material. By combining the characteristics of the titanium alloy and the iron-nickel-cobalt alloy, the finally prepared magnetic isolation material with counter potential crystals has a highly magnetoconductive surface and a non-permeable and non-magnetized matrix, and can be well applied in magnetic fluid seal systems.

### BRIEF DESCRIPTION OF THE DRAWINGS

FIG. 1 is a schematic structural view of the present disclosure;

FIG. 2 is a schematic structural view of a drilling container in the present disclosure; and

FIG. 3 is schematic diagram showing results of property testing of magnetic isolation materials prepared in Examples 1 to 7, Comparative Example 1 and Comparative Example 2.

In the figures: 1, non-magnetoconductive layer; 2, fusion layer; 3, magnetic isolation layer, 4, drilling container; 5, drill bit.

### DETAILED DESCRIPTION

The technical solutions in the examples of the present disclosure will be clearly and completely described below with reference to the accompanying drawings in the examples of the present disclosure. It is apparent that the described examples are only a part of the examples, rather than all of the examples of the present disclosure. All other examples obtained by those of ordinary skill in the art based on the examples of the present disclosure without creative work are within the protection scope of the present disclosure.

### Example 1

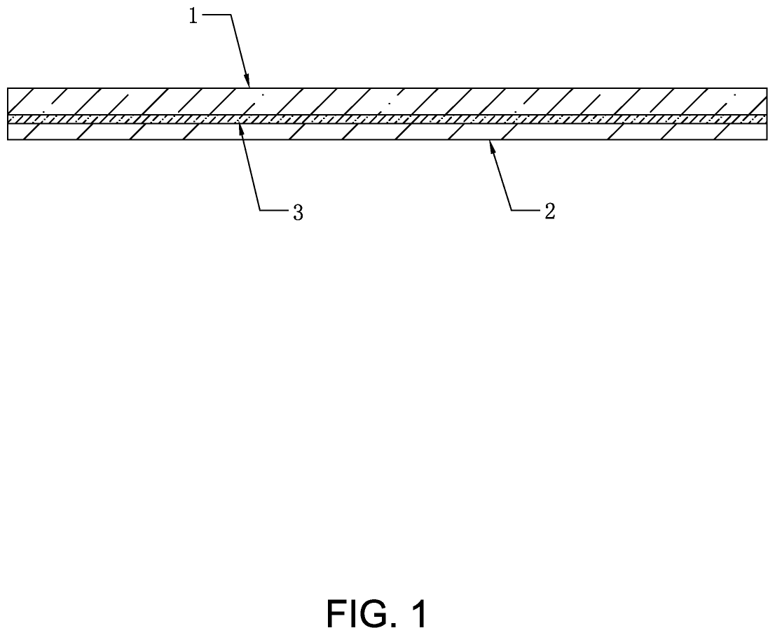

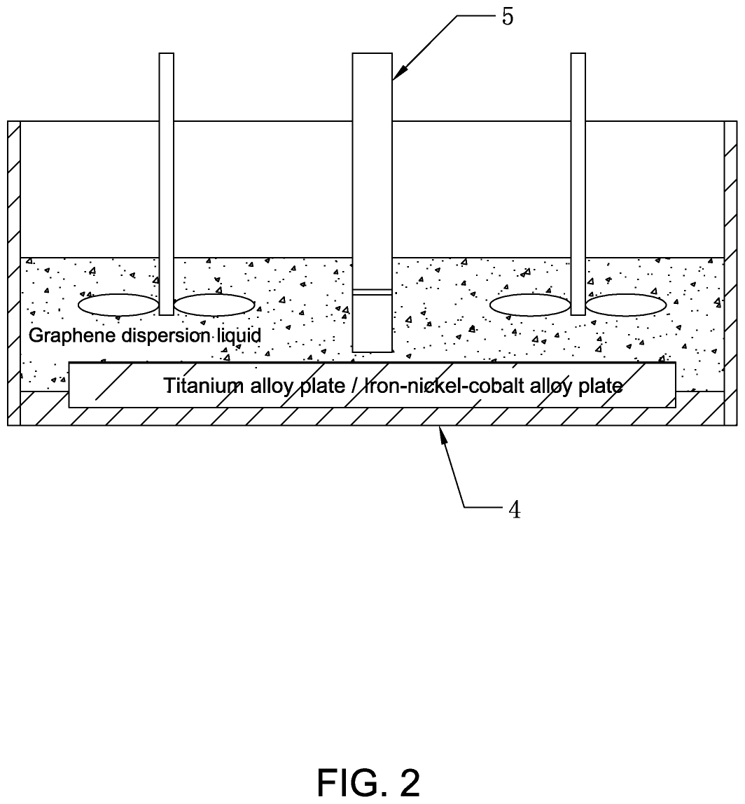

As shown in FIG. 1 to FIG. 3, an example of the present disclosure provides a magnetic isolation material with counter potential crystals. The magnetic isolation material with counter potential crystals includes a non-magnetoconductive layer 1, a fusion layer 2 and a magnetic isolation layer 3. The non-magnetoconductive layer 1 is connected with the magnetic isolation layer 3 through the fusion layer 2. The non-magnetoconductive layer 1 is made of a graphene-reinforced titanium alloy, the magnetic isolation layer 3 is made of a graphene-reinforced iron-nickel-cobalt alloy, and the fusion layer 2 is formed by intermediate fusion of the non-magnetoconductive layer 1 and the magnetic isolation layer 3 when a temperature is reduced from 3652° C. to 1215.5° C.

In some examples, the non-magnetoconductive layer 1 has a thickness of 15 μm, the fusion layer 2 has a thickness of 5 μm, and the magnetic isolation layer 3 has a thickness of 10 μm.

The present disclosure further provides a preparation method of the magnetic isolation material with counter potential crystals, including the following steps:
S1: preparation of non-magnetoconductive layer 1:
S11: adding first graphene into cetyltrimethylammonium bromide, adding acetic acid for surface modification of the graphene, and then adding the surface-modified first graphene into a DMF solvent for dispersion to obtain a first graphene dispersion liquid;
S12: putting a titanium alloy plate with a rough surface in a drilling container 4, adding the first graphene dispersion liquid into the drilling container 4, and drilling the rough surface of the titanium alloy plate by a drill bit 5 at a drill bit 5 speed of 500 r/min and an advancing speed of 30 mm/min while stirring the first graphene dispersion liquid at a speed of 500 r/min, thereby obtaining a graphene/titanium alloy slurry;
S13: washing and drying the graphene/titanium alloy slurry to obtain graphene/titanium alloy powder, and
S14: melting and forming the graphene/titanium alloy powder by selective laser melting to obtain a graphene-reinforced titanium alloy;
S2: preparation of magnetic isolation layer 3:
S21: adding second graphene into cetyltrimethylammonium bromide, adding acetic acid for surface modification of the second graphene, and then adding the surface-modified second graphene into a DMF solvent for dispersion to obtain a second graphene dispersion liquid;
S22: putting an iron-nickel-cobalt alloy plate with a rough surface in a drilling container 4, adding the second graphene dispersion liquid into the drilling container 4, and drilling the rough surface of the iron-nickel-cobalt alloy plate by a drill bit 5 at a drill bit 5 speed of 500 r/min and an advancing speed of 30 mm/min while stirring the second graphene dispersion liquid, thereby obtaining a graphene/iron-nickel-cobalt alloy slurry;
S23: washing and drying the graphene/iron-nickel-cobalt alloy slurry to obtain graphene/iron-nickel-cobalt alloy powder; and
S24: melting and forming the graphene/iron-nickel-cobalt alloy powder by selective laser melting to obtain a graphene-reinforced iron-nickel-cobalt alloy; and
S3: preparation of magnetic isolation material with counter potential crystals: respectively fusing the graphene-reinforced titanium alloy obtained in step S1 and the graphene-reinforced iron-nickel-cobalt alloy obtained in step S2 by selective laser melting, and carrying out intermediate fusion on the graphene-reinforced titanium alloy and the graphene-reinforced iron-nickel-cobalt alloy when a temperature is reduced from 3652° C. to 1215.5° C., thereby finally forming the magnetic isolation material with counter potential crystals having a non-magnetoconductive layer 1, a fusion layer 2 and a magnetic isolation layer 3, the part formed by the intermediate fusion being the fusion layer 2.

In some examples, in step S1, an amount of the first graphene added is 0.1 wt. % of a total amount of the graphene and titanium alloy powder in the graphene/titanium alloy slurry.

In some examples, in step S2, an amount of the second graphene added is 0.1 wt. % of a total amount of the graphene and iron-nickel-cobalt alloy powder in the graphene/iron-nickel-cobalt alloy slurry.

In some examples, in step S2, the graphene/titanium alloy slurry and the graphene/iron-nickel-cobalt alloy slurry are both dried at a temperature of 75° C. for 6 h.

### Example 2

As shown in FIG. 1 to FIG. 3, an example of the present disclosure provides a magnetic isolation material with counter potential crystals. The magnetic isolation material with counter potential crystals includes a non-magnetoconductive layer 1, a fusion layer 2 and a magnetic isolation layer 3. The non-magnetoconductive layer 1 is connected with the magnetic isolation layer 3 through the fusion layer 2. The non-magnetoconductive layer 1 is made of a graphene-reinforced titanium alloy, the magnetic isolation layer 3 is made of a graphene-reinforced iron-nickel-cobalt alloy, and the fusion layer 2 is formed by intermediate fusion of the non-magnetoconductive layer 1 and the magnetic isolation layer 3 when a temperature is reduced from 3652° C. to 1217° C.

In some examples, the non-magnetoconductive layer 1 has a thickness of 25 μm, the fusion layer 2 has a thickness of 8 μm, and the magnetic isolation layer 3 has a thickness of 15 μm.

The present disclosure further provides a preparation method of the magnetic isolation material with counter potential crystals, including the following steps:
S1: preparation of non-magnetoconductive layer 1:
S11: adding first graphene into cetyltrimethylammonium bromide, adding acetic acid for surface modification of the graphene, and then adding the surface-modified first graphene into a DMF solvent for dispersion to obtain a first graphene dispersion liquid;
S12: putting a titanium alloy plate with a rough surface in a drilling container 4, adding the first graphene dispersion liquid into the drilling container 4, and drilling the rough surface of the titanium alloy plate by a drill bit 5 at a drill bit 5 speed of 600 r/min and an advancing speed of 35 mm/min while stirring the first graphene dispersion liquid at a speed of 600 r/min, thereby obtaining a graphene/titanium alloy slurry;
S13: washing and drying the graphene/titanium alloy slurry to obtain graphene/titanium alloy powder; and
S14: melting and forming the graphene/titanium alloy powder by selective laser melting to obtain a graphene-reinforced titanium alloy,

S2: preparation of magnetic isolation layer 3:
S21: adding second graphene into cetyltrimethylammonium bromide, adding acetic acid for surface modification of the second graphene, and then adding the surface-modified second graphene into a DMF solvent for dispersion to obtain a second graphene dispersion liquid;
S22: putting an iron-nickel-cobalt alloy plate with a rough surface in a drilling container, adding the second graphene dispersion liquid into the drilling container, and drilling the rough surface of the iron-nickel-cobalt alloy plate by a drill bit at a drill bit speed of 600 r/min and an advancing speed of 35 mm/min while stirring the second graphene dispersion liquid, thereby obtaining a graphene/iron-nickel-cobalt alloy slurry;
S23: washing and drying the graphene/iron-nickel-cobalt alloy slurry to obtain graphene/iron-nickel-cobalt alloy powder; and
S24: melting and forming the graphene/iron-nickel-cobalt alloy powder by selective laser melting to obtain a graphene-reinforced iron-nickel-cobalt alloy; and
S3: preparation of magnetic isolation material with counter potential crystals:
respectively fusing the graphene-reinforced titanium alloy obtained in step S1 and the graphene-reinforced iron-nickel-cobalt alloy obtained in step S2 by selective laser melting, and carrying out intermediate fusion on the graphene-reinforced titanium alloy and the graphene-reinforced iron-nickel-cobalt alloy when a temperature is reduced from 3652° C. to 1217° C., thereby finally forming the magnetic isolation material with counter potential crystals having a non-magnetoconductive layer 1, a fusion layer 2 and a magnetic isolation layer 3, the part formed by the intermediate fusion being the fusion layer 2.

In some examples, in step S1, an amount of the first graphene added is 0.2 wt. % of a total amount of the graphene and titanium alloy powder in the graphene titanium alloy slurry.

In some examples, in step S2, an amount of the second graphene added is 0.2 wt. % of a total amount of the graphene and iron-nickel-cobalt alloy powder in the graphene iron-nickel-cobalt alloy slurry.

In some examples, in step S2, the graphene/titanium alloy slurry and the graphene iron-nickel-cobalt alloy slurry are both dried at a temperature of 85° C. for 7 h.

### Example 3

As shown in FIG. 1 to FIG. 3, an example of the present disclosure provides a magnetic isolation material with counter potential crystals. The magnetic isolation material with counter potential crystals includes a non-magnetoconductive layer 1, a fusion layer 2 and a magnetic isolation layer 3. The non-magnetoconductive layer 1 is connected with the magnetic isolation layer 3 through the fusion layer 2. The non-magnetoconductive layer 1 is made of a graphene-reinforced titanium alloy, the magnetic isolation layer 3 is made of a graphene-reinforced iron-nickel-cobalt alloy, and the fusion layer 2 is formed by intermediate fusion of the non-magnetoconductive layer 1 and the magnetic isolation layer 3 when a temperature is reduced from 3652° C. to 1218.5° C.

In some examples, the non-magnetoconductive layer 1 has a thickness of 35 μm, the fusion layer 2 has a thickness of 10 μm, and the magnetic isolation layer 3 has a thickness of 20 μm.

The present disclosure further provides a preparation method of the magnetic isolation material with counter potential crystals, including the following steps:
S1: preparation of non-magnetoconductive layer 1:
S11: adding first graphene into cetyltrimethylammonium bromide, adding acetic acid for surface modification of the graphene, and then adding the surface-modified first graphene into a DMF solvent for dispersion to obtain a first graphene dispersion liquid;
S12: putting a titanium alloy plate with a rough surface in a drilling container 4, adding the first graphene dispersion liquid into the drilling container 4, and drilling the rough surface of the titanium alloy plate by a drill bit 5 at a drill bit 5 speed of 800 r/min and an advancing speed of 40 mm/min while stirring the first graphene dispersion liquid at a speed of 800 r/min, thereby obtaining a graphene/titanium alloy slurry;
S13: washing and drying the graphene/titanium alloy slurry to obtain graphene/titanium alloy powder; and
S14: melting and forming the graphene/titanium alloy powder by selective laser melting to obtain a graphene-reinforced titanium alloy;
S2: preparation of magnetic isolation layer 3:
S21: adding second graphene into cetyltrimethylammonium bromide, adding acetic acid for surface modification of the second graphene, and then adding the surface-modified second graphene into a DMF solvent for dispersion to obtain a second graphene dispersion liquid;
S22: putting an iron-nickel-cobalt alloy plate with a rough surface in a drilling container, adding the second graphene dispersion liquid into the drilling container, and drilling the rough surface of the iron-nickel-cobalt alloy plate by a drill bit at a drill bit speed of 800 r/min and an advancing speed of 40 mm/min while stirring the second graphene dispersion liquid, thereby obtaining a graphene/iron-nickel-cobalt alloy slurry;
S23: washing and drying the graphene/iron-nickel-cobalt alloy slurry to obtain graphene/iron-nickel-cobalt alloy powder; and
S24: melting and forming the graphene/iron-nickel-cobalt alloy powder by selective laser melting to obtain a graphene-reinforced iron-nickel-cobalt alloy; and
S3: preparation of magnetic isolation material with counter potential crystals:
respectively fusing the graphene-reinforced titanium alloy obtained in step S1 and the graphene-reinforced iron-nickel-cobalt alloy obtained in step S2 by selective laser melting, and carrying out intermediate fusion on the graphene-reinforced titanium alloy and the graphene-reinforced iron-nickel-cobalt alloy when a temperature is reduced from 3652° C. to 1218.5° C., thereby finally forming the magnetic isolation material with counter potential crystals having a non-magnetoconductive layer 1, a fusion layer 2 and a magnetic isolation layer 3, the part formed by the intermediate fusion being the fusion layer 2.

In some examples, in step S1, an amount of the first graphene added is 0.3 wt. % of a total amount of the graphene and titanium alloy powder in the graphene/titanium alloy slurry.

In some examples, in step S2, an amount of the second graphene added is 0.3 wt. % of a total amount of the graphene and iron-nickel-cobalt alloy powder in the graphene/iron-nickel-cobalt alloy slurry.

In some examples, in step S2, the graphene titanium alloy slurry and the graphene/iron-nickel-cobalt alloy slurry are both dried at a temperature of 90° C. for 8 h.

### Example 4

Example 4 is substantially the same as Example 1, except that: in Example 4, the fusion layer 2 is formed by intermediate fusion of the non-magnetoconductive layer 1 and the magnetic isolation layer 3 when a temperature is reduced from 3652° C. to 1216.5° C.

### Example 5

Example 5 is substantially the same as Example 1, except that: in Example 5, the fusion layer 2 is formed by intermediate fusion of the non-magnetoconductive layer 1 and the magnetic isolation layer 3 when a temperature is reduced from 3652° C. to 1218° C.

### Example 6

Example 6 is substantially the same as Example 1, except that: in Example 6, the non-magnetoconductive layer 1 has a thickness of 20 μm, the fusion layer 2 has a thickness of 7 μm, and the magnetic isolation layer 3 has a thickness of 13 μm.

### Example 7

Example 7 is substantially the same as Example 1, except that: in Example 7, the non-magnetoconductive layer 1 has a thickness of 22 μm, the fusion layer 2 has a thickness of 6 μm, and the magnetic isolation layer 3 has a thickness of 18 μm.

### Comparative Example 1

Comparative Example 1 is a comparative example of Example 1, and is different in that: in Comparative Example 1, fusion of common graphene and a titanium alloy and fusion of common graphene and an iron-nickel-cobalt alloy are used.

### Comparative Example 2

Comparative Example 2 is a comparative example of Example 1, and is different in that: in Comparative Example 2, fusion of a common titanium alloy and a common iron-nickel-cobalt alloy is used.

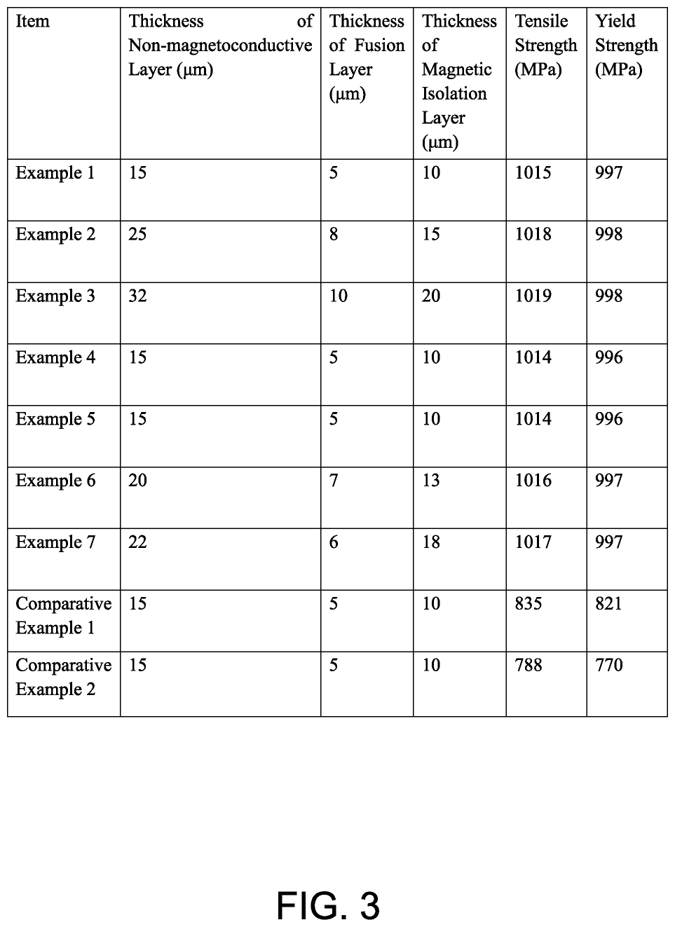

The magnetic isolation materials prepared in Examples 1 to 7, Comparative Example 1 and Comparative Example 2 are subjected to property testing. The results of the property testing are shown in FIG. 3.

The magnetic isolation materials with counter potential crystals in Examples 1 to 7 are prepared by partially fusing the graphene-reinforced titanium alloy and the graphene-reinforced iron-nickel-cobalt alloy. During the preparation of the alloy powder by the drill bit, the highly dispersed graphene is directly coated on the surface of the alloy powder to form a more obviously refined microstructure. The formed magnetic isolation material with counter potential crystals has a tensile strength of up to 1019 MPa and a yield strength of up to 998 MPa, exhibiting more excellent mechanical properties than the magnetic isolation materials prepared by fusion of common graphene and a titanium alloy and fusion of common graphene and an iron-nickel-cobalt alloy (Comparative Example 1), and obviously higher mechanical properties than the magnetic isolation material prepared by fusion of a common titanium alloy and a common iron-nickel-cobalt alloy (Comparative Example 2). In addition, in view of the titanium alloy being non-magnetized and non-magnetoconductive, the graphene-reinforced iron-nickel-cobalt alloy is partially fused on the graphene-reinforced titanium alloy, which imparts a highly magnetoconductive surface to the titanium alloy. Moreover, this magnetic isolation material well utilizes high heat dissipation, high processability and low thermal expansivity of the iron-nickel-cobalt alloy, can maintain good magnetic stability at high working temperature, and improves physical and mechanical properties of the magnetic isolation material. By combining the characteristics of the titanium alloy and the iron-nickel-cobalt alloy, the finally prepared magnetic isolation material with counter potential crystals has a highly magnetoconductive surface and a non-permeable and non-magnetized matrix, and can be well applied in magnetic fluid seal systems.

It should be finally noted that the above is only preferred examples of the present disclosure and is not intended to limit the present disclosure. Although the present disclosure has been described in detail with reference to the foregoing examples, those skilled in the art can still modify the technical solutions recorded in the above examples, or make equivalent replacements on part of technical features. Any modification, equivalent replacement, or improvement made within the spirit and principle of the present disclosure shall fall into the protection scope of the present disclosure.

What is claimed is:

1. A magnetic isolation material with counter potential crystals, wherein the magnetic isolation material with counter potential crystals comprises a non-magnetoconductive layer, a fusion layer and a magnetic isolation layer, the non-magnetoconductive layer being connected with the magnetic isolation layer through the fusion layer, wherein the non-magnetoconductive layer is made of a graphene-reinforced titanium alloy, the magnetic isolation layer is made of a graphene-reinforced iron-nickel-cobalt alloy, and the fusion layer is formed by intermediate fusion of the non-magnetoconductive layer and the magnetic isolation layer when a temperature is reduced from 3652° C. to 1217±1.5° C.

2. The magnetic isolation material with counter potential crystals according to claim 1, wherein the non-magnetoconductive layer has a thickness of 15-35 μm, the fusion layer has a thickness of 5-10 μm, and the magnetic isolation layer has a thickness of 10-20 μm.

3. A preparation method of the magnetic isolation material with counter potential crystals according to claim 1, comprising the following steps:
S1: preparation of non-magnetoconductive layer:
S11: adding first graphene into cetyltrimethylammonium bromide, adding acetic acid for surface modification of the graphene, and then adding the surface-modified first graphene into a DMF (N,N-dimethylformamide) solvent for dispersion to obtain a first graphene dispersion liquid;
S12: putting a titanium alloy plate with a rough surface in a drilling container, adding the first graphene dispersion liquid into the drilling container, and drilling the rough surface of the titanium alloy plate by a drill bit at a drill bit speed of 500-800 r/min and an advancing speed of 30-40 mm/min while stirring the first graphene dispersion liquid at a speed of 500-800 r/min, thereby obtaining a graphene/titanium alloy slurry;
S13: washing and drying the graphene/titanium alloy slurry to obtain graphene/titanium alloy powder; and
S14: melting and forming the graphene/titanium alloy powder by selective laser melting to obtain a graphene-reinforced titanium alloy;
S2: preparation of magnetic isolation layer:
S21: adding second graphene into cetyltrimethylammonium bromide, adding acetic acid for surface modification of the second graphene, and then adding the surface-modified second graphene into a DMF solvent for dispersion to obtain a second graphene dispersion liquid;
S22: putting an iron-nickel-cobalt alloy plate with a rough surface in a drilling container, adding the second graphene dispersion liquid into the drilling container, and drilling the rough surface of the iron-nickel-cobalt alloy plate by a drill bit at a drill bit speed of 500-800 r/min and an advancing speed of 30-40 mm/min while stirring the second graphene dispersion liquid, thereby obtaining a graphene/iron-nickel-cobalt alloy slurry;
S23: washing and drying the graphene/iron-nickel-cobalt alloy slurry to obtain graphene/iron-nickel-cobalt alloy powder; and
S24: melting and forming the graphene/iron-nickel-cobalt alloy powder by selective laser melting to obtain a graphene-reinforced iron-nickel-cobalt alloy; and
S3: preparation of magnetic isolation material with counter potential crystals: respectively fusing the graphene-reinforced titanium alloy obtained in step S1 and the graphene-reinforced iron-nickel-cobalt alloy obtained in step S2 by selective laser melting, and carrying out intermediate fusion on the graphene-reinforced titanium alloy and the graphene-reinforced iron-nickel-cobalt alloy when a temperature is reduced from 3652° C. to 1217±1.5° C., thereby finally forming the magnetic isolation material with counter potential crystals having a non-magnetoconductive layer, a fusion layer and a magnetic isolation layer, the part formed by the intermediate fusion being the fusion layer.

4. The preparation method of the magnetic isolation material with counter potential crystals according to claim 3, wherein in step S1, an amount of the first graphene added is 0.1-0.3 wt. % of a total amount of the graphene and titanium alloy powder in the graphene/titanium alloy slurry.

5. The preparation method of the magnetic isolation material with counter potential crystals according to claim 4, wherein the amount of the first graphene added is 0.3 wt. % of the total amount of the graphene and titanium alloy powder in the graphene/titanium alloy slurry.

6. The preparation method of the magnetic isolation material with counter potential crystals according to claim 3, wherein in step S2, an amount of the second graphene added is 0.1-0.3 wt. % of a total amount of the graphene and iron-nickel-cobalt alloy powder in the graphene/iron-nickel-cobalt alloy slurry.

7. The preparation method of the magnetic isolation material with counter potential crystals according to claim 6, wherein the amount of the second graphene added is 0.3 wt. % of the total amount of the graphene and iron-nickel-cobalt alloy powder in the graphene/iron-nickel-cobalt alloy slurry.

8. The preparation method of the magnetic isolation material with counter potential crystals according to claim 3, wherein in step S2, the graphene/titanium alloy slurry and the graphene/iron-nickel-cobalt alloy slurry are both dried at a temperature of 75-90° C. for 6-8 h.
